(19) United States
(12) Patent Application Publication
(10) Pub. No.: US 2002/0107007 A1
(43) Pub. Date: Aug. 8, 2002

(54) Method for wireless telephony payment and an apparatus therefor

(76) Inventor: Howard Gerson, Overland Park, KS (US)

Correspondence Address: LATHROP & GAGE LC, 2345 GRAND AVENUE, SUITE 2800, KANSAS CITY, MO, 64108, US

(21) Appl. No.: 10/107,572

(22) Filed: Mar. 27, 2002

Related U.S. Application Data
(62) Division of application No. 09/587,153, filed on Jun. 2, 2000.

(51) Int. Cl. H04M 11/00

(52) U.S. Cl. 455/414; 455/406; 455/407

(57) ABSTRACT

The present invention is directed to an apparatus and a method for conducting financial payment transactions, authorizations therefor, and notification thereof through wireless or cellular communication devices. The apparatus and method of the present invention includes a point-of-sale authorization device, a central processing computer, and a communication device, such as a wireless telephone.

### BACKGROUND OF THE INVENTION

1. Field of the Invention

The present invention relates generally to an apparatus and method to effectuate payment through a mobile telephony system, and pertains more specifically to an apparatus and method for conducting financial payment transactions, and authorizations therefor to purchase goods and services as desired.

2. Description of the Related Art

Many individuals enjoy the convenience of owning and using wireless or mobile telephones, or cellular telephones as a means to facilitate communications and to make telephone calls when a conventional line or permanent telephone is not within reach or when the individual is “on the go.” The sharp increase in demand over the years for wireless services highlights a growing trend of general acceptance for this mode of communication. As wireless communication becomes more prevalent in society, an opportunity for a new, convenient payment method exists for subscribers to access an account through the mobile telephone and utilize this account to authorize the purchase of goods and services anywhere, anytime.

There is a need in the retail industry to provide another purchasing option as an alternative to credit cards or checks for customers without a high capital investment by the retailer. Small specialty stores, which number 2.7 million of which only 60,000 have point-of-sale (POS) debit capability, have a particular need for another payment option. While widely accepted, the credit card payment system excludes potential customers who do not have a credit card, or do not want to use their credit card for the particular purchase. It would be advantageous, therefore, that some trusted and convenient payment method was available to facilitate the purchase of the goods and services.

In view of the foregoing, it is an objective of the present invention to provide a streamlined and automated payment method through the use wireless telecommunication that is relatively quick and convenient thereby enabling a cash payment through a mobile telephone.

### SUMMARY OF THE INVENTION

Briefly described, and in accordance with an embodiment thereof, the present invention discloses a payment method through wireless telecommunication services by mobile units accessing a central processing computer and the mobile unit transferring funds to a merchant. The system includes an account for a mobile-unit user that is funded through prepayment, credit card, debit card, or other financial account, and having an authorization PIN code corresponding to the account. Further, the payment system includes a network of subscribing merchants, with each merchant having a unique Merchant Code to identify the particular merchant. Each subscribing merchant is equipped with point-of-sale terminals (POSTs) that can access the cental processing computer payment system of the present invention.

In one method of practicing the present invention, the mobile terminal user initiates the payment transaction by accessing the central processing computer, which verifies whether the mobile-unit user is an authorized user by requesting the authorization PIN code for the mobile unit user and further determines that the merchant from which the mobile terminal user is attempting to purchase a product or service is a subscriber to the System by requesting input of its Merchant Code. The amount of purchase is entered by the mobile unit user. The central processing computer verifies that the mobile unit account has a sufficient amount to cover the specific transaction, and if verified, a transaction-specific authorization code is provided by the central processing computer to the mobile unit user. The transaction code is entered by the mobile unit user (i.e., the consumer) on a payment slip provided by the merchant, or alternatively, provided directly to the merchant. The merchant uses the POST to access the central processing computer and enters the transaction-specific authorization code. The central processing computer confirms to the merchant that the mobile unit user has confirmed payment for the good or service and the funds are being held for the merchant.

In an alternative method of practicing the present invention, the merchant initiates the transaction. In this embodiment, the mobile-unit user expresses their desire to use the telephonic payment method of the present invention and provides the authorized merchant with their authorization PIN code. The merchant enters the central processing computer through the POST and provides the merchant code, the mobile-unit users authorization PIN code, and the amount of purchase. The central processing computer verifies that it is a subscribing merchant, a valid mobile unit user, that the mobile user unit has sufficient funds to cover the transaction. If verified, the central processing computer telephones the mobile user unit. The mobile user unit provides his authorization PIN code and enters whether the mobile user unit wants to pay for the transaction.

In either embodiment, if there is insufficient funds to cover the transaction, the transaction is denied, and a message is displayed on the mobile unit and the POST of the denial. The mobile user unit then has the option of replenishing the account telephonically.

The present invention provides a convenient method for payment for goods and services for mobile telephone subscribers that is automated, efficient and less cumbersome than previous payment methods. These and other advantages of the present invention will become apparent upon reading the following detailed descriptions and studying the various figures of the drawings.

### BRIEF DESCRIPTION OF THE DRAWINGS

The invention, together with further objectives and advantages thereof, may best be understood by reference to the following description taken in conjunction with the accompanying drawings in which:

FIG. 1 depicts a diagram for a telephonic payment mechanism in accordance with an embodiment of the present invention;

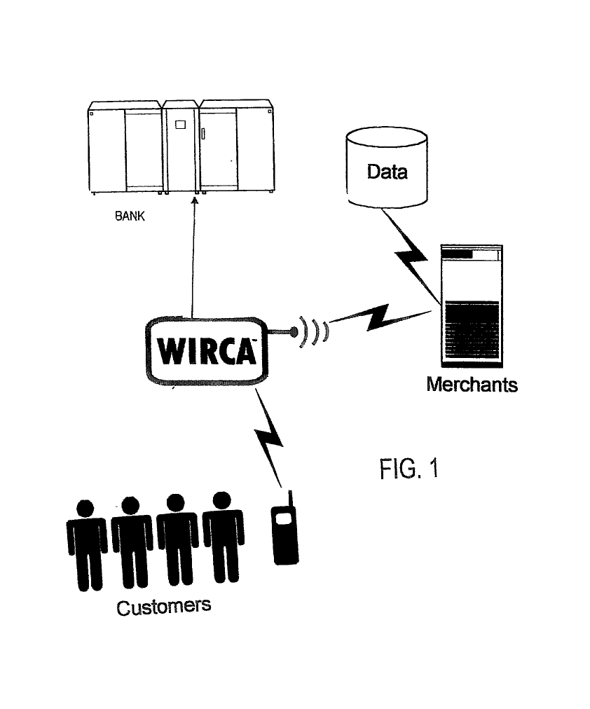

FIG. 2 is a block diagram of the process for telephonically operated payment system operating in accordance with a consumer-initiated embodiment of the present invention; and

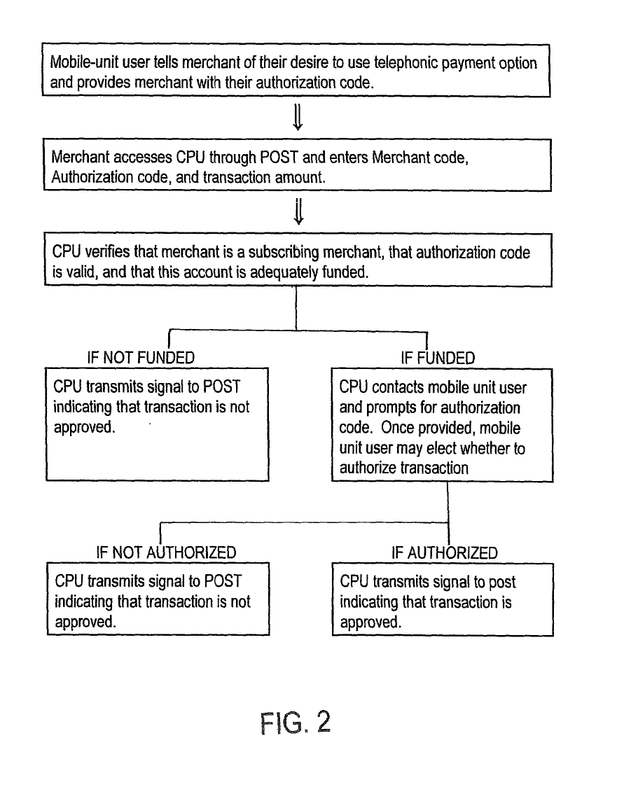

FIG. 3 is a block diagram of the process for telephonically operated payment system operating in accordance with a merchant-initiated embodiment of the present invention.

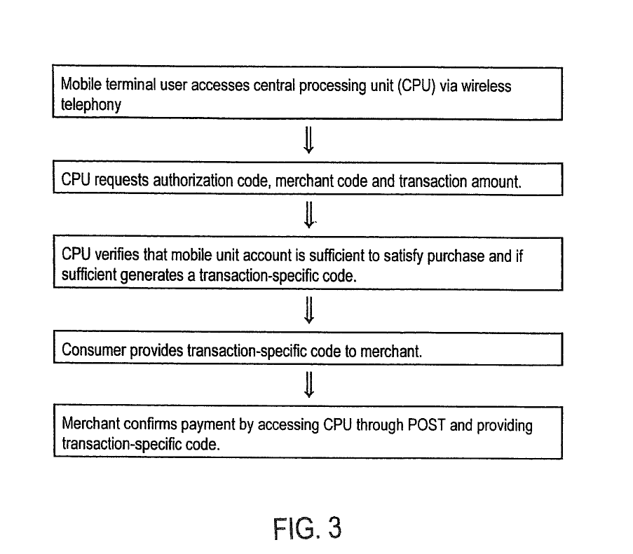

### DETAILED DESCRIPTION OF THE PREFERRED EMBODIMENTS

The present invention discloses an apparatus and a method for conducting financial payment transactions, authorizations therefor, and notification thereof through wireless or cellular communication devices. The apparatus and method of the present invention comprises a point-of-sale authorization device, a central processing computer, and a communication device, such as a wireless telephone.

Point-of-sale (POS) authorization devices are found in various establishments and are used in conjunction with the sale of goods and/or services. The point-of-sale device may be located at the location of the seller and/or service provider, such as at a retail store or office, and/or the point-of-sale device may be located at the site of the goods or service provider or vendor, such as in cases when the sale is a telephone order or mail order. Preferably, the POS is a Palm computer hand-held device such as Palm Pilot or a Windows CE device.

The apparatus of the present invention also comprises a central processing computer for processing the transaction requests, data pertaining thereto, and the authorizations pertaining thereto. The central processing unit comprises a 600 MHz, Windows NT server with a Rocket modem, manufactured by Rocket Inc. to enable multiple phone accessibility to the central processor. The central processing unit further comprises an Intel Dialogic board for computerized telephony. The processing unit recognizes tones, is menu-driven and password based.

The POS is linked to the central processing computer via a communications system or link, such as, for example, a communication network and/or a telephone network or line. The communications system may be any communications system and may include telecommunication systems, satellite communications systems, radio communication systems, digital satellite communications systems, personal communications services communication systems, cable television systems, broadband communication systems, as well as any other appropriate communications system. The point-of-sale device transmits signals and/or data to the central processing computer as well as receives signals and/or data from the central processing computer.

The apparatus also comprises a communication device, such as a Palm computer hand-held device, a wireless telephone or a cellular telephone, that receive signals from the central processing computer and likewise is equipped with a transmitter for transmitting signals data to the central processing computer. Preferably, the communication device is wireless so that it may be carried by the consumer at any time and at any location. A wireless telecommunications link is used in order to link the central processing computer with the communication device.

The central processing unit is further linked to a bank or other financial institution in which the system has one or more accounts. The central processing unit is linked via a communications system, link and/or medium, such as, for example, a communication network and/or a telephone network or line such that the accounts for the mobile unit subscribers are accessible by the central processing computer.

Initially, an interested mobile phone user needs to set up an account for this payment system. The account for a mobile-unit user is funded through cash prepayment, credit card or debit card funding, or transfer from some other financial account. Each account will be provided an authorization PIN code corresponding to the account. The mobile unit user may authorize the payment system of the present system to replenish automatically the account through a particular financial account or credit card upon the account reaching a certain minimum balance.

Alternatively, once the account is funded and set up, the mobile phone user can replenish the account remotely by authorizing the system to access a previously identified financial account.

The payment apparatus and method of the present invention commences operation when payment is required at the point-of-sale or other appropriate location of the merchant. Upon choosing the mobile telephone payment option, two distinct transaction types are available: The consumer-initiated transaction and the merchant-initiated transaction.

For the consumer-initiated transaction, the mobile terminal user initiates the payment transaction by accessing the central processing unit, which verifies whether the mobile-unit user is an authorized user by requesting the authorization PIN code or recognizing the user through existing caller ID technology (CID) or through voice-recognition technology for the mobile unit user and further determines that the merchant from which the mobile terminal user is attempting to purchase a product or service is a subscriber to this payment option by requesting input of its Merchant Code. The amount of purchase is entered by the mobile unit user. The central processing computer verifies that the mobile unit account has a sufficient amount to cover the specific transaction, and if verified, a transaction-specific authorization code is provided by the central processing computer to the mobile unit user. The transaction code is entered by the mobile unit user (i.e., the consumer) on a payment slip provided by the merchant, or alternatively, provided directly to the merchant. The merchant uses the POST to access the central processing unit and enters the transaction-specific authorization code. The central processing unit confirms for the merchant that the mobile unit user has confirmed payment for the good or service and the funds are being held for the merchant in the account.

In an alternative method of practicing the present invention, the merchant initiates the transaction. In this embodiment, the mobile-unit user expresses their desire to use the telephonic payment option and provides the subscribing merchant with their authorization PIN code. The attendant or point-of-sale device operator will activate the apparatus in any typical manner, such as by obtaining a phone line, and enter their merchant code and the mobile phone unit code. The information pertinent to the transaction and the mobile unit user is then transmitted to the central processing computer. The central processing computer processes the information and data pertinent to the transaction and to the particular account and requests that the point-of-sale operator enter the transaction amount. The central processing unit verifies that the merchant is a subscribing merchant and that the mobile unit user is a valid user through the merchant code and authorization PIN code, respectively. Further, the central processing computer confirms that the account has sufficient funds to cover the transaction or if the transaction will deplete the account of its value.

If the account is sufficient and the merchant and mobile unit user are subscribing members to the system, the central processing unit contacts the mobile unit user through the mobile communication unit and requests the authorization PIN number for the user. If the appropriate number is entered, the central processing unit provides information identifying the transaction and may include the name of the store or the service provider and the amount of the transaction. The information transmitted may also provide the time of the transaction, and the location (i.e., city, town, village, state, country, etc.) of the transaction. The information data may also be supplemented to include the type of goods and/or services involved in the transaction, if such information can be entered at the point-of-sale device.

The mobile unit user has the option to confirm or deny the transaction. The apparatus, or the central processing computer, awaits the cardholder's response to its transmission. During this time, the mobile unit user may either approve and thus authorize, the transaction, or disapprove and thus void the transaction. The central processing unit determines if the mobile unit user has made a reply or response within a pre-defined time limit. If a reply is received, the response may then be transmitted to, and received by, the POST. If the cardholder does not reply to the central processing computer within a pre-specified time, the central processing computer may transmit a signal to the point-of-sale device indicating that, with the exception of receiving the authorization of the cardholder, the transaction is otherwise approved. The central processing computer may also simply transmit a signal indicating that the transaction is not authorized and, therefore, should be canceled or voided. The point-of-sale device operator may then either proceed to complete the transaction, try to obtain additional information from the purchaser, or cancel the transaction.

The central processing computer, after receiving the response from the mobile unit user, identifies the response and determines whether the mobile unit user has authorized the transaction. If the cardholder's response is to not authorize the transaction, the central processing computer transmits a signal to the POST, which will notify the point-of-sale device operator that the transaction is not authorized and, therefore, should be canceled or voided. The point-of-sale device operator may then cancel the transaction.

If, however, the central processing computer identifies the mobile unit user's response as authorizing the transaction, the central processing computer transmits a signal to the POST, which notifies the point-of-sale device operator that the transaction is authorized. The point-of-sale device operator may then complete the transaction. Thereafter, operation of the apparatus will cease for this particular transaction.

The mobile unit user may also program the communication device to automatically authorize transactions. In this regard, the communication device may be programmable so as to receive and to analyze the transaction information and respond to same automatically with preset or programmed responses. The communication device or the central processing computer may also be programmable so as to limit or restrict the amounts and types of transactions, or the goods and services which may be purchased through the telephonic payment system.

The apparatus and method of the present invention provides for real-time financial transactions, authorization therefor, and notification thereof.

While the invention has been described herein with reference to certain preferred embodiment, these embodiments have been presented by way of example only, and not to limit the scope of the invention. Accordingly, the scope of the invention should be defined only in accordance with claims that follow.

What is claimed is:

1. An apparatus for accessing a money account corresponding to a particular user and effectuating a payment from the money account from a remote location through a communication device, the apparatus comprising:
a receiver for accessing a money account and having a stored authorization code corresponding to the money account;
a processor for processing a payment transaction on the money account in conjunction with said receiver receiving said authorization code, said processor generating a first signal containing information for one of approving and disapproving the transaction;
a transmitter for transmitting a notification signal to the communication device associated with the account holder, wherein the communication device is one of a cellular telephone, a wireless telephone, a mobile telephone, and a display cellular telephone; and wherein the receiver receives a reply signal from the one of a cellular telephone, a wireless telephone, a mobile telephone, and a display cellular telephone containing information for one of approving and disapproving the transaction; and
a point-of-sale terminal for accessing said processor and for receiving a second signal from said processor for one of approving or disapproving the transaction.

2. A method for accessing a money account corresponding to a particular user and effectuating a payment from the money account from a remote location through a communication device, the method comprising the steps of:
receiving funds for the money account,
creating a unique authorization code pertaining to the money account;
storing said authorization code in a processor;
processing a transaction on the account in response to processor being contacted by a remote user and supplying the authorization code for the money account;
generating a first signal, wherein said first signal contains information for one of approving and disapproving the transaction;
contacting a communication device associated with the money account and supplying the signal for one of approving and disapproving the transaction; and
receiving a signal for one of approving or disapproving the transaction from the communication device associated with the money account.
